(19) United States
(12) Patent Application Publication
(10) Pub. No.: US 2002/0157002 A1
(43) Pub. Date: Oct. 24, 2002

(54) System and method for secure and convenient management of digital electronic content

(76) Inventors: Thomas S. Messerges, Schaumburg, IL (US); Ezzat A. Dabbish, Cary, IL (US); Larry Puhl, West Dundee, IL (US); Dean Vogler, Algonquin, IL (US)

Correspondence Address: MOTOROLA, INC., 1303 EAST ALGONQUIN ROAD, IL01/3RD, SCHAUMBURG, IL, 60196

(21) Appl. No.: 09/942,010

(22) Filed: Aug. 29, 2001

Related U.S. Application Data
(60) Provisional application No. 60/284,739, filed on Apr. 18, 2001.

(51) Int. Cl. H04L 9/00

(52) U.S. Cl. 713/155; 713/200; 380/279

(57) ABSTRACT

A domain-based digital rights management (DRM) method and system. A domain has one or more communication devices, such as user devices that share a common cryptographic key of the domain. There may be a plurality of domains in a digital rights management environment and the domains may additionally be overlapping. A domain authority, in combination with a digital rights management module of a communication device, operates to selectively register and unregister the communication device to the one or more domains and to control access to encrypted digital content information.

### FIELD OF THE INVENTION

The present invention relates generally to communication systems and more specifically to content management systems for securely accessing digital content.

### BACKGROUND OF THE INVENTION

Tremendous continued growth in the digital content market is predicted. The Internet, for instance, has brought about many changes in the way people conduct business. Consumers can easily shop and purchase products using their home computers. These purchased products can be delivered using UPS, FedEx, or other conventional means. However, when a product is not a physical item, but a digital item, the Internet itself can be used as the delivery mechanism. A surprising number of products can be represented digitally and transferred to buyers using the Internet. Potential digital objects, such as music, software, video, or books are often cited; but other digital products, such as tickets, pictures, or stamps can also be considered. These are all examples of content. As used herein content refers to digital information that is locked with a key and may be delivered real-time, such as streaming data, or data that is stored and accessed at a later time. Such content would include audio books, videos, electronic games, video clips, DVD and MPEG movies, MP3 music files, business data such as electronic mail and documents, upgrades to portable devices like three-way calling and ring modes for cellular telephones.

With the advent of the Internet and more powerful mobile computing devices, consumers will soon demand continuous access to digital information, anytime and anywhere. The connectivity between devices such as pagers, mobile phones, set-top boxes, home computers, and automobile entertainment systems will open up many avenues for new businesses. The popularity of digital content, such as MP3 music files, electronic games, and DVD movies, is growing at a tremendous rate. Wireless devices are on the verge of making access to this digital content easy and intuitive.

Due to this value and due to the rapidly growing popularity and availability of digital content, Content owners, however, are worried, that with the advent of these new devices, their digital content will become more susceptible to illicit copying and distribution. In order to avoid widespread piracy, like that prevalent on the Internet (i.e., Napster), content providers are planning to rely on secure content management mechanisms. Providers of content want to make sure that their rights are protected and that reasonable distribution rules are followed. In an information-based economy, digital data has inherent value for which ownership rights and copyright laws need to be observed.

In pursuit of this market and to satisfy content providers, many hardware and software vendors are introducing frameworks for securely handling digital content. Digital Rights Management (DRM) is a popular phrase used to describe the protection of rights and the management of rules related to accessing and processing digital information. These rights and rules govern various aspects of a digital object, such as who owns the object, how and when an object can be accessed, and how much an object may cost. It is often the case that rules associated with a particular digital object become very complex. As such, software systems are often needed to develop, assign, and manage these rules.

Many newly emerged frameworks, however, have been criticized as being overly cumbersome and inconvenient for consumers to use. Secure methods to protect digital content often come at the expense of convenience to the endusers. It is clear that new and better solutions are needed.

One type of digital rights management scheme commonly discussed is the copy-based approach. In this type of system, a master copy of the content is stored and managed by a digital rights management system running on a PC or server. In the prior art check-in/check-out approach, content is cryptographically tied to a trusted system that is trusted to decide when and if to provide requested digital content information. There is typically a limited number of available copies for each piece of digital content. The copy-based approach has a digital rights management kernel that is responsible for releasing copies of the digital master. Users request copies for their user devices and the digital rights management kernel tracks the number of released copies. When a communication device, such as a portable wireless device, for instance, checks out a copy of a piece of digital content, the trusted system cryptographically ties a copy of the content to the device receiving the content and decrements the number of copies available for check-out. When a copy is returned, the trusted system increments the number of available copies accordingly. The trusted system will not allow copies of the digital content to be checked-out when the number of available copies is zero.

Consider, for example, the Secure Digital Music Initiative (SDMI) framework which manages a music check-in and check-out policy to control digital music content. A master copy of the music is stored and managed by a digital rights management system running on a server or PC. The number of copies of a song that can be checked-out is fixed. So, when all copies are checked-out, a new copy cannot be released until one copy is checked-in. In order to keep music secure, the SDMI framework stipulates that check-out is the only means for transferring content to portable devices and is quite user unfriendly. The SDMI system, accordingly, is a digital rights management scheme that has received very poor reviews from the public.

In a typical scenario, a user's music collection is stored in a cryptographically protected music library on his PC. Users that own a portable music player can copy music from their music library onto their player. A digital rights management system controls the library and is responsible for enforcing the number of copies allowed to leave the library. In an SDMI compliant system, the digital rights management software manages a music check-in and check-out policy. For SDMI, the number of copies of a song that can be checked out is fixed. When all the copies are checked out, at least one of the copies must be checked back in before a check-out can be performed by another device. In order to keep the music secure, check-in and check-out are the only means by which music can be transferred onto portable devices.

An example of a copy-based system 100 for preventing content piracy, in which content is cryptographically protected by tying it to a purchasing host, is depicted in FIG. 1. In this system, the content provider 102 maintains a content library 104. When a piece of content is purchased, the content provider 102 cryptographically ties the content to the purchasing host PC or server 110. The host 110, which has a digital rights management system 114, receives the content from the provider and stores it in an encrypted content library 112. The host's digital rights management system 114 keeps a content list 116 that is used to track the number of available copies for each piece of content. Any portable device 118a, 118b, 118c can request a piece of content. If there is an available copy, the digital rights management system 114 will use a cryptographic process to transfer a copy to the portable device. The digital rights management system 114 will also decrement the number of available copies for the transferred piece of content. In FIG. 1, there are three copies for each piece of content. For example, content tagged #4536 is not checked-out by any devices, so there are still three available copies. Content tagged #6123, however, is currently checked-out by three devices 118a, 118b, 118c, so there are zero available copies. The digital rights management system 114 will not allow a fourth device to check-out content tagged #6123 until one of the devices checks-in one of the copies.

Overall, this prior-art method for controlling access to digital music is widely considered to be intrusive and cumbersome. Particularly bothersome is the fact that users need to check-in their copies of music before loading new music. Users of the system face security controls every time they transfer music into their devices. In similar systems that do not enforce copy control security, check-in is not required, thus the user's experience is greatly enhanced. Of course, without security, piracy of digital content is very likely, so content providers will not want to supply content to these systems.

The implementation of security needs to be balanced. Content providers will not trust systems with too little security; however consumers will not like systems with forbidding security. The prior art copy-based check-in/check-out approaches suggested for SDMI and other digital rights management systems provide security, but do not satisfy the needs of the end user. The system requires that the user encounter security every time content is moved to a user device. This excessive security leads to a poor user experience. Because the trusted system to which content is accessed very often, i.e. every time content is moved to the user device requesting content or from the user device when it is being checked back in, the approach is most often implemented on a user's local server or PC rather than at a remote server. Security is accordingly difficult to maintain and ensure in an open system utilizing a PC or other local server device.

In light of the foregoing, it can be seen that there is thus an unmet need in the art to allow for the secure and seamless management of digital content that is less cumbersome, while still maintaining adequate security. The security requirements of digital content should be protected while also providing an enjoyable user experience for the end user.

### BRIEF DESCRIPTION OF THE DRAWINGS

The novel features believed characteristic of the invention are set forth in the claims. The invention itself, however, as well as a preferred mode of use, and further objects and advantages thereof, will best be understood by reference to the following detailed description of an illustrative embodiment when read in conjunction with the accompanying drawings, wherein:

FIG. 1 is a block diagram of a copy-based digital rights management system, in accordance with the prior art.

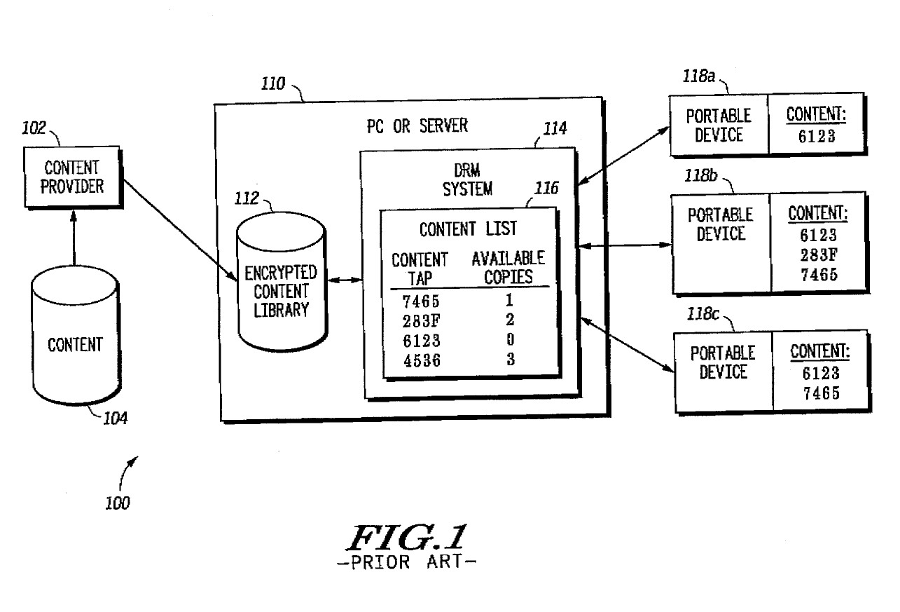

FIG. 2 illustrates participants of a domain-based digital rights management system, in accordance with an embodiment of the present invention.

FIG. 3 illustrates overlapping domains, in accordance with the present invention.

FIG. 4 is a block diagram of a domain-based digital rights management system, in accordance with the present invention.

FIG. 5 illustrates the concept of a domain having one or more user communication devices, in accordance with the present invention.

FIG. 6 illustrates how content is bound to a domain, in accordance with the present invention.

FIG. 7 illustrates the content package, in accordance with the present invention.

FIG. 8 is a block diagram of a user communication device, in accordance with the present invention.

FIG. 9 is a block diagram illustrating the architecture of a user device, in accordance with the present invention.

FIG. 10 is a block diagram illustrating the architecture of a domain authority, in accordance with the present invention.

FIG. 11 is a block diagram illustrating the architecture of a content provider, in accordance with the present invention.

### DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawing.

The present invention provides a convenient way for consumers to access desired digital content that manages content and prevents piracy using a domain-based digital rights management system, as opposed to the burdensome copy-based digital rights management system of the prior art. Rather than restrict access to content based upon a check-in/check-out policy in which security restrictions are encountered every time content is loaded into or out of a communication device, such as a user device (UD), access to digital content is managed using a domain-based approach in which the user must contend with security only when a new user device is to be purchased or added to a domain or when an old user device is to be removed from a domain. Access to content is typically restricted to a limited number of registered devices of a domain. As used herein, a domain contains one or more user devices, typically up to a predefined number of communication devices, that all share a common cryptographic key associated with the domain. A user who owns multiple devices will want to enroll these devices into the same domain.

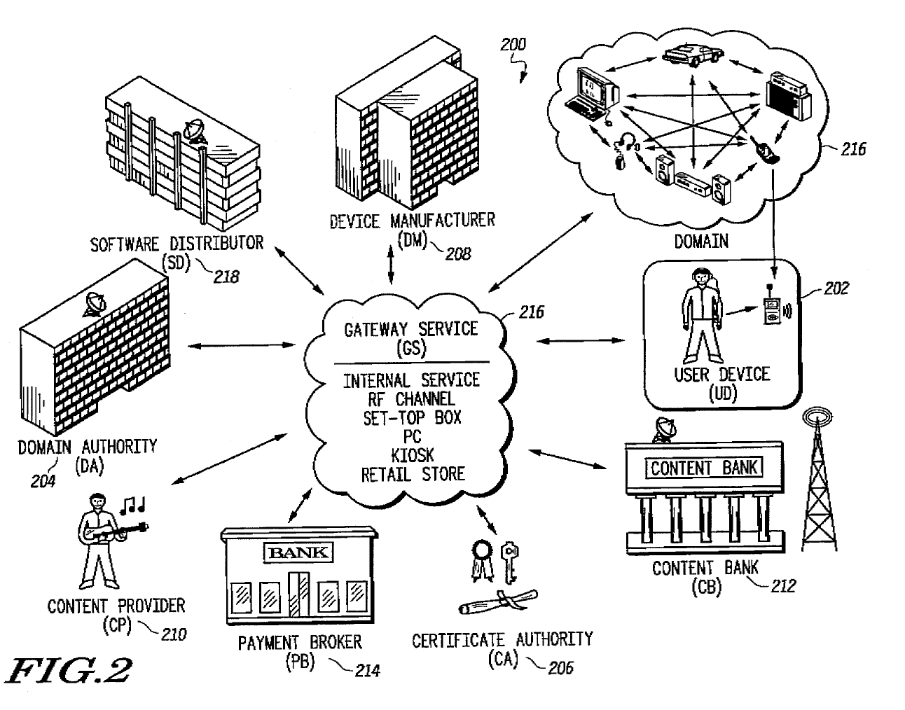

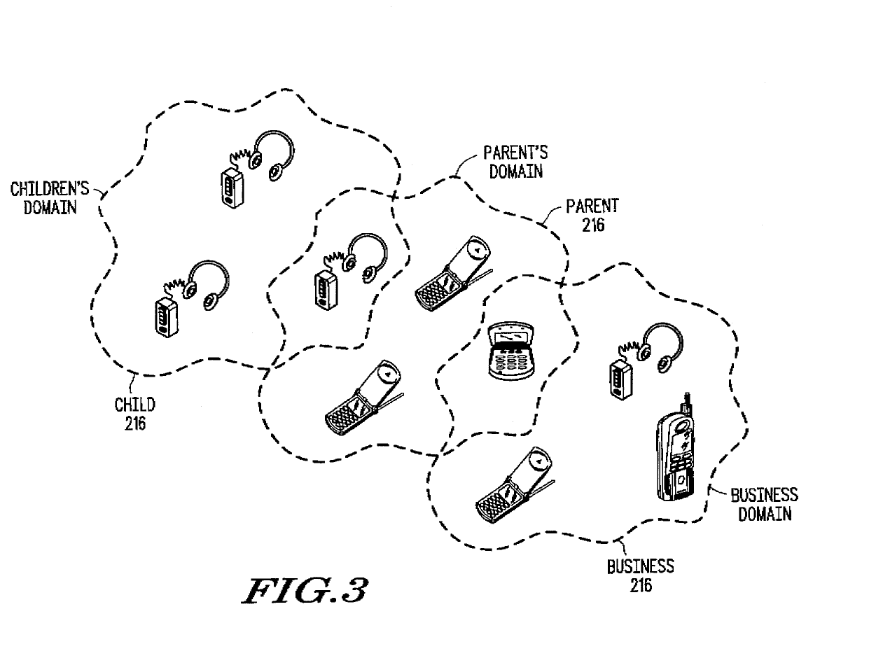

Referring now to FIG. 2, participants that may engage in an exemplary digital rights management system 200, in accordance with the present invention, are illustrated. It is recognized that the functionality representative of the various participants may be performed by different entities or that the functionality performed by various participants may be accordingly performed by fewer or more entities without departing from the spirit and scope of the invention. A consumer or user may purchase a communication device 202, referred to as a user device (UD), which is any electronic device that is used to access and/or manipulate digital content. Examples of user devices include a mobile phone capable of playing (rendering) music, a car stereo, a set-top box, a personal computer, etc. A user may and probably will own multiple user devices that he or she will want to register in one or more domains, which may or may not overlap, to which the user belongs. In a situation in which at least one communication user device of a first domain simultaneously is registered to a second domain, the first and second domains are said to be overlapping domains for that device; diagram 300 of FIG. 3 provides an illustration of exemplary overlapping domains 216child, 216parent, 216biz. A user device may be portable and wireless, such as a cellular telephone, and thus able to easily connect to the wireless Internet. Infra-red (IR) as well as limited range technology, such as that embodied in the Bluetooth standard, may be used. Bluetooth user devices may reach the Internet by connecting with a bridge device, such as a PC or kiosk.

The domain authority (DA) 204 is responsible for registering (adding) and unregistering (removing) user devices from the one or more domains. The domain authority adds a device to a domain by first checking to make sure the device is legitimate. Legitimate user devices can be detected because only they will have access to the proper certificates and keys. The domain authority may also check a revocation list, provided by a certificate authority (CA) 206, to make sure the device's keys and certificates are still valid. Once a device is deemed authentic, the domain authority will send the user device the proper keys, certificates, and commands needed to enroll it into a domain. The domain authority can also remove devices from a domain by sending the user device a command to delete its domain data. Finally, the domain authority is responsible for restricting the number of user devices allowed in a domain and for monitoring for the fraudulent enrollment and removal of devices.

The device manufacturer (DM) 208 makes user devices that enforce content usage rules and otherwise have secure digital rights management capabilities. For instance, the device manufacturer may securely embed keys into a user device so that each user device can be uniquely identified to the other digital rights management system participants. The device manufacturer will also be responsible for embedding the certificate authority's authentication keys, certificates, or other secrets into a device. The software used by a user device to operate within a domain-based digital rights management system may be either pre-installed on the user device or obtained from a software distributor (SD) 218.

A content provider (CP) 210 sells or otherwise provides content to registered user devices of a domain. The content provider, for instance, may be the artist that created the content, a large content distributor, or an on-line store that is selling the content. The main job for content providers is to establish a set of rules and associate those rules with the content and the domain that purchases the content. Consider, for example, how content provider band XYZ might attach rules to their latest single titled “ABC.” After recording “ABC” in the usual manner, they produce a file ABC.wav and since the band is interested in selling this song via the Internet, the song is compressed into an MP3 file, thus creating ABC.mp3. The MP3 file is next encrypted and associated with usage rules, such as who can play the song, who can copy the song, who can edit the song, whether the song can be loaned, the fee structure for playing the song, and whether rules can be added to the song and by whom. These usage rules can be added using a standard application. Packaging of the content by the content provider concerns manipulating the content rules rather than the content itself.

Storage of content may occur in a variety of ways and is typically a function of the type of content and the respective storage capabilities of the user device, the domain, and the overall system. Content may be stored in the user device, sent to an on-line account at a content bank (CB) 212, for example, copied to a user's PC or other available server, or delivered to the consumer as legacy content. A content bank is an entity responsible for storing and maintaining a user's content account. Content in an account need not necessarily be stored in an account associated with a single end-user. Instead, a pointer to a single copy of the content can be maintained, thereby ensuring that the size of a user's content account(s) do not become too large. For example, upon an end-user purchasing a song, the song is delivered to the end-users content account and stored on the user's portable user device. The rules associated with this piece of content may be transferred to the content account and to the portable device. When the user decides to load the content into the user device, the content back is responsible for ensuring that it supplies the content only to authentic, rule-abiding devices, in this case the user device, and to this end may use certificates or secrets issued by the certificate authority (CA) 206 to authenticate the user device.

Public-keys associated with maintaining required security in the digital rights management system are managed by certificate authorities (CA) 206 and payments for the services and/or content are managed by payment brokers (PB) 214. For instance, a certificate authority is a trusted third-party organization or a company that manages the digital certificates, public-private key pairs, or other items that are used to verify that content is being handled by valid and secure devices. Methods to accomplish this verification might include a public-key, digital signature scheme, or perhaps a secret sharing scheme. In a public-key based scheme, certificates can be used to guarantee that participants and devices in a digital rights management system are, in fact, who they claim to be. In a secret sharing scheme, the certificate authority is responsible for distributing the shared secrets. In either scheme, the certificate authority will need to have agreements with the device manufacturers, the content distributors, and the payment brokers. The certificate authority will also need to have methods to both issue and revoke certificates or secrets. The certificate authority is preferably an off-line system, thus every time content is rendered it is not necessary to contact the certificate authority.

The Gateway Server(s) (GS) 216 provide communication channels or links between the participants in the system; participants may alternately communicate directly. Examples of gateway server(s) may include but are not limited to an Internet or RF-connected in-store kiosk, a set-top box, or a PC. These participants of a digital rights management system, particularly the user device and domain authority, will be discussed in further detail below.

User devices 202 can be assigned to a particular domain by registering with a Domain Authority (DA) 204. When a device registers into a domain 216, it has “joined” the domain. Similarly, devices can “leave” a domain by canceling their registration. The domain authority 204 enforces registration policies, such as limiting the number of devices in a domain 216 and limiting the number of times a device can join and leave a domain. The domain authority 204 also looks for potential fraud by tracking which devices are joining and leaving the domains. Excessive activity may indicate that a device is trying to abuse the system. Such devices can then be prohibited from further registration activities.

The domain authority 204 assigns portable devices into a domain by providing them with a domain ID, which is linked to the device in a tamper-resistant manner. The linking of a domain ID to a user device is accomplished using embedded serial numbers and cryptographic elements such as secret keys and public-key certificates. These cryptographic elements are operated on by secure digital rights management systems running on the user device and domain authority. Only the domain authority will have the ability to grant access to a domain. Thus, the domain authority will provide assurance to content providers that only devices that are not attempting to defraud the system will be members of a domain.

When selling digital content, a content provider can query the user device and/or domain authority to authenticate a particular domain. This query process uses a standard cryptographic authentication protocol to be certain that eavesdroppers and hackers cannot defraud the system. Once the content provider is assured that a domain is valid, content can be sold by cryptographically binding it to the purchasing domain's ID. Devices outside of this domain cannot access content that was cryptographically tied to another domain, so this content is safe from piracy.

The encrypted content can be openly stored on any host PC or server of the system. Any portable device can request a piece of this content. The host merely transfers the content to the requesting device without performing a check-out operation. The security of the content is ensured because it is cryptographically tied to a specific domain. Widespread piracy of fraudulently copied music is prevented because the domain authority will only permit a limited number of devices into each domain. The digital rights management system in the user device prevents tampering, so hackers will not be able to gain illegitimate access to content.

The security of this system of the present invention will be less cumbersome than previous approaches because users infrequently need to register devices in and out of domains. In the check-in and check-out system, users encounter security restrictions every time content is loaded into and out of their portable devices. Users will only need to contend with security when they purchase a new device or wish to add a user device to one or more domains.

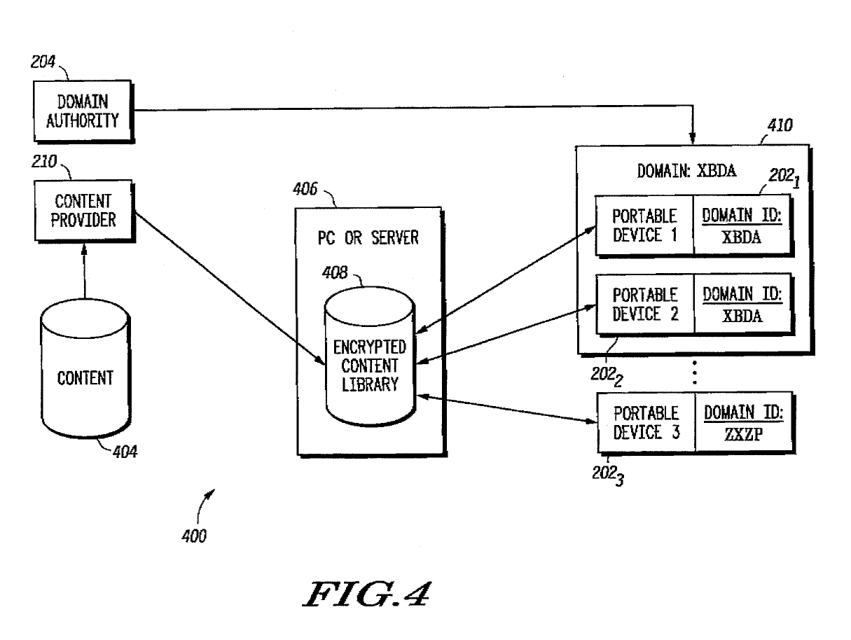

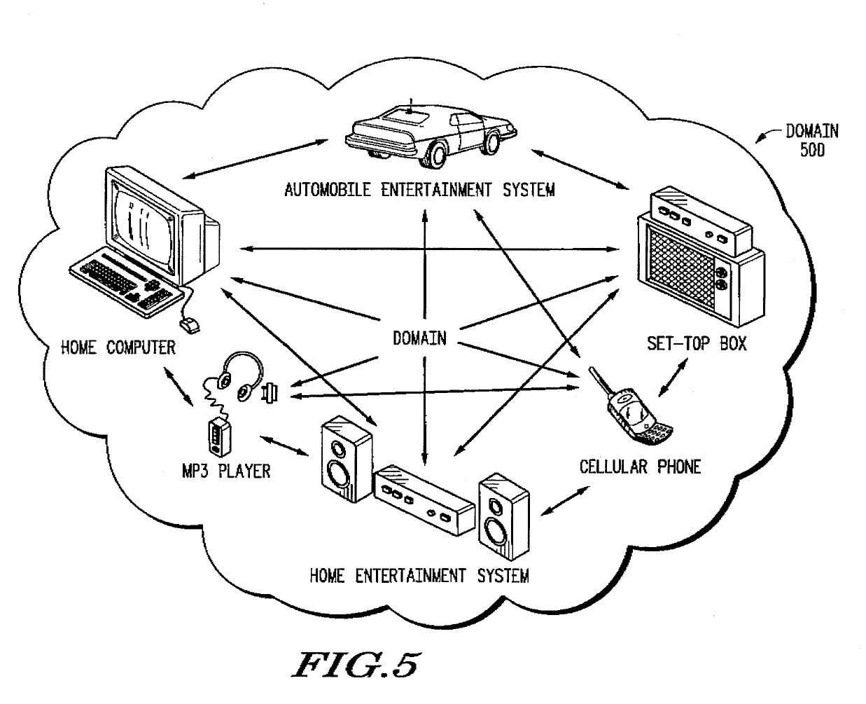

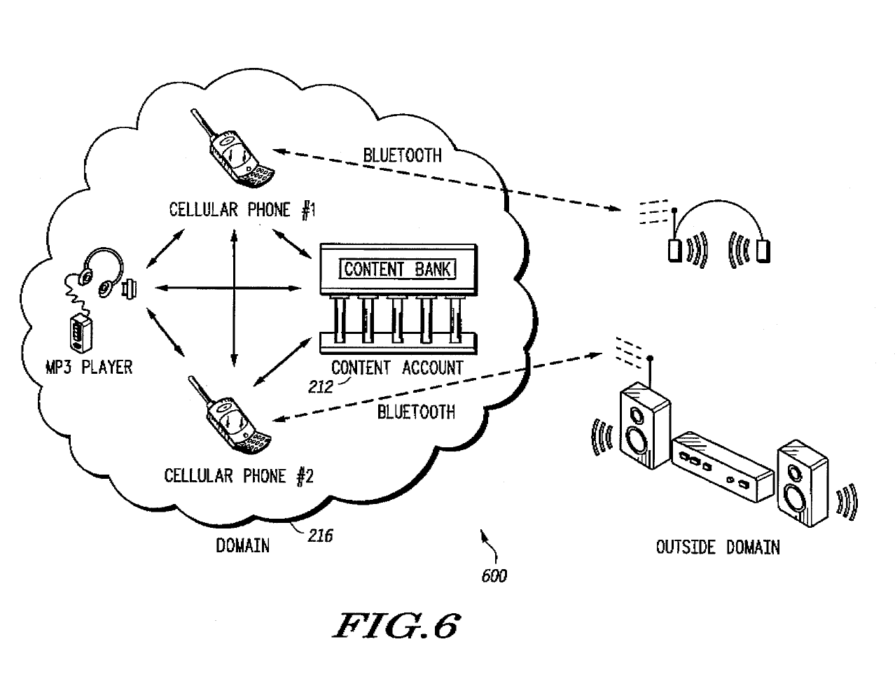

A block diagram that further illustrates a domain-based digital rights management system for securely managing access to digital content is shown in FIG. 4. The Domain Authority assigned communication devices, such as portable user devices 202₁, 202₂, 202₄ into a domain, of which there are shown two in this example: domain XBDA 410 and Domain ZXZP 412, and enforces domain registration policies. Content from content library 404 is protected by cryptographically tying it to one or more domains 410, 412, not to the PC or Server 406. Only devices tied to a domain, or authorized by a domain to receive content, may receive content that is cryptographically tied to a domain. All devices registered to a domain 216 will be interconnected in that they will all have access to content within the domain, as illustrated in the exemplary domain 500 which has a variety of devices such as a home computer, MP3 Player, automobile entertainment system, set-top box, cellular phone, home entertainment system, of FIG. 5. This also means that devices of one domain, Domain ZXZP 412, for instance, cannot access content that is cyptographically tied to another domain, such as Domain XBDA 410. As illustrated in system 600 of FIG. 6, domain 216 in this example contains two cellular phones #1, #2 and an MP3 Player all in communication with content bank 212; the headset and stereo system outside the domain, however, do not have access to the content account of content bank 212. It is noted that while the encrypted content is shown stored in an encrypted content library 408 on a PC or Server 406, the encrypted content may additionally be stored on a communication device, such as Portable Devices 1, 2, or 3, denoted as 202₁, 202₂, 202₄, respectively, if so desired.

It is clear that sufficiently strong cryptographic protocols should be used for communication channels between participants in the domain-based digital rights management system and method of the present invention. Standard protocols, such as WTLS class 3 or TLS, can be used when communicating with Internet enabled devices. Strong symmetric-key cryptography, such as triple-DES or AES, can be used to protect the content. For authentication and signatures, elliptic-curve or RSA public-key cryptography may be used. The integrity of content can be preserved using secure hash functions such as SHA-1. Consider an example in which a device manufacturer will manufacture a user device. After being manufactured, the user device will be certified (either by the device manufacturer or another trusted authority) to be a legitimate device. This certification can be achieved using a certificate that can be verified with a public key or a shared secret key. A certified user device will contain this certificate (or a reference to the certificate) and also a secret key corresponding to this certificate that is either a private key (paired with the certificate's public key) or a secret key (shared with the trusted authorities of the digital rights management system). The domain authority will be similarly configured and certified. When a user wishes to enroll a user device into a domain, the user device and the domain authority engage in a protocol to authenticate each other. This authentication is achieved using a standard method based on the public-key or shared key certificates that were previously installed in the user device and domain authority. Once authenticated, the domain authority will create and send the user device a domain certificate for the new domain. This certificate will be provided to content providers, when new content is purchased for this domain. Once a content provider has a user device's domain certificate, the content provider can assign content to this domain using the information in the certificate. The above procedures can be accomplished with either public-key or symmetric-key cryptographic methods. The distribution of keys is simpler in the public-key approach than in the symmetric-key approach.

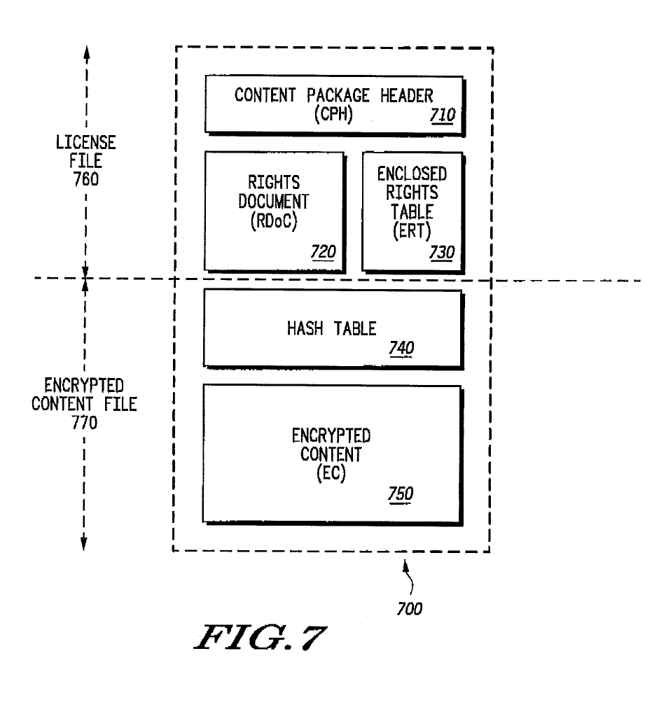

Requested content is provided, initially, from a content provider or other entity within the digital rights management system having access to the requested content, as part of a content package. Referring now to FIG. 7, the overall structure of a content package 700 is illustrated. A content package 700 is a concatenation of five objects: a header CPH 710, a rights document Rdoc 720, an electronic rights table or encoded rights table 730, a hash 740, and the encrypted content 750. The content package's header 710 is mainly used to indicate the existence and size of the different objects of the content package 700. The usage rules for the content are specified in the rights document 720. These rules will typically be in a standard format. The rights document will also contain the certificates, public keys, and some of the hash values that are necessary for a user device to verify the rules and integrity of the other objects in the content package.

An Encoded Rights Table (ERT) 730, which is a more efficient representation of the rights document, is included in the content package. The encoded rights table approach is significant in that embodies a binary representation of data that departs from a formal language approach, such as XrML, and has a small size and fast performance that are especially attractive to low-power or otherwise constrained user devices. A constrained device refers to a communication device that may have physical characteristics for screen size, RAM size, ROM size, etc. based upon constraints such as processing power and task loading, power/battery concerns, mass-storage limitations, and bandwidth restrains between the device and other infrastructure elements.

The encoded rights table 730 is designed so that the digital usage rights of other rights documents can be transcribed into the encoded rights table format of the present invention, meaning that a system using the encoded rights table can coexist with other digital rights management system that may otherwise be unwieldy in a constrained device. Transcribing from one digital rights management language to an encoded rights table representation may be done using a transcoder. The transcoder will parse the data from the source language and recode it to the encoded rights table format or vice-versa. Content providers and owners of digital content have the freedom to choose a preferred digital rights management system, making use of translation software where needed.

The encoded rights table has several sections delineated using preassigned codewords or tokens, including the ERT_VERSION, the TOKEN_OBJECT_INFO, the TOKEN_WORK_HASH, the TOKEN_KEY_ID, the TOKEN_xxx_RIGHT, and the TOKEN_ERT_SIG. The ERT_VERSION section gives the version number of the encoded rights table. Subsequent updates to the encoded rights table format will require new versions to be recognized by newer software and also previous versions to be recognized in order to maintain backwards compatibility. The TOKEN_OBJECT_INFO section has information concerning the digital object associated with the encoded rights table, such as a URL for obtaining more information about the digital object or for purchasing a copy of the digital object. The TOKEN_WORK_HASH section contains a cryptographic hash of the digital object associated with the encoded rights table and indicates which hash algorithm is to be used. The TOKEN_KEY_ID section of the encoded rights table specifies the keys needed to access the digital object. An example of this would be a Content Encryption Key (CEK) assigned to a recipient using a public-key encryption algorithm. The TOKEN_xxx_RIGHT section contains the usage rules for the digital object. For example, a TOKEN_PLAY_RIGHT section might be provided to specify that a particular key in the TOKEN_KEY_ID section has the “play” right for the digital object. Other rights that may be included in the encoded rights table specification include stream, loan, copy, transfer, and install. Within each right, there is also information that identifies the part of the digital object to which this right refers. Finally, the TOKEN_ERT_SIGN section of the encoded rights table includes information that identifies the signature algorithm used to sign the hash of the encoded rights table data, the signer's public or symmetric key, and the signature data itself.

The encoded rights table 730 is added to the content package 700 by the content provider 210 to reduce the complexity of enforcing the rules. By using an encoded rights table, the software on the user device can be simpler at the expense of a slightly larger content package and some additional preprocessing steps by the content provider.

The integrity of the content and the binding between the content and the rights document is maintained using a hash. The hash enables an approach to verify the content package's integrity.

The last part of a content package is the encrypted content (EC) 750 itself. To prevent piracy, this content will be kept encrypted. The decryption key for the content is embedded into the rights document and will only be available to the owner or purchaser of the content.

As indicated by the dashed line, the objects of the content package 700 may optionally be provided by two files: a license file 760 containing the content provider header (CPH), RDoc, and encoded rights table and an encrypted content file 770 containing the hash of the content, the encrypted content, and also a duplicate (not shown) of the content package header 710.

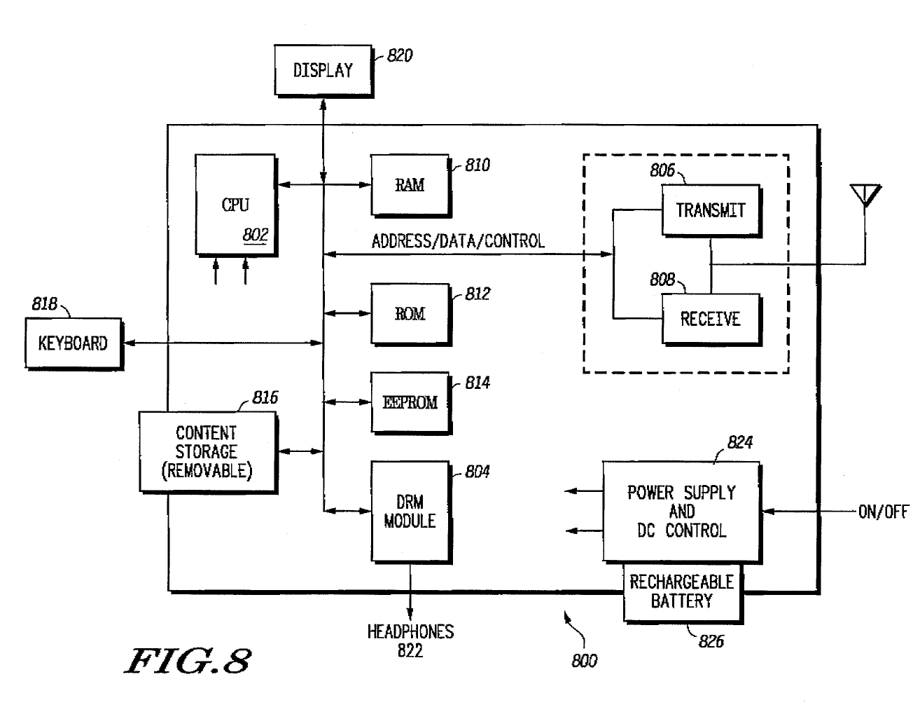

The architecture and preferred operation of a user device in accordance with the present invention will now be discussed. Referring now to FIG. 8, a block diagram 800 of a user device 202, such as a mobile phone, etc., operable in a domain-based digital rights management environment is shown. The communication device has a CPU processing element 802 and digital rights management module 804, which may contain firmware or software, that are operable to control operation of the transmitter 806 and receiver 808 in a domain-based environment. The user device has various memory elements such as the Random Access Memory (RAM) 810, Read Only Memory (ROM) 812, Electrically Erasable Programmable Read Only Memory (EEPROM) 814, etc., as well as optional removable content storage 816. Power Supply and DC Control block 824, as well as rechargeable battery 826, operate to provide power to the user device 202. As will become apparent, the software or firmware of the digital rights management module operates in combination with a domain authority to add and remove the user device to one or more domains and thus to selectively receive and decrypt digital content based upon membership in the one or more domains. The user device additionally will have peripheral elements, such as a keyboard 818, display 820, and headphones 822, that are useful for communicating with a user of the user device.

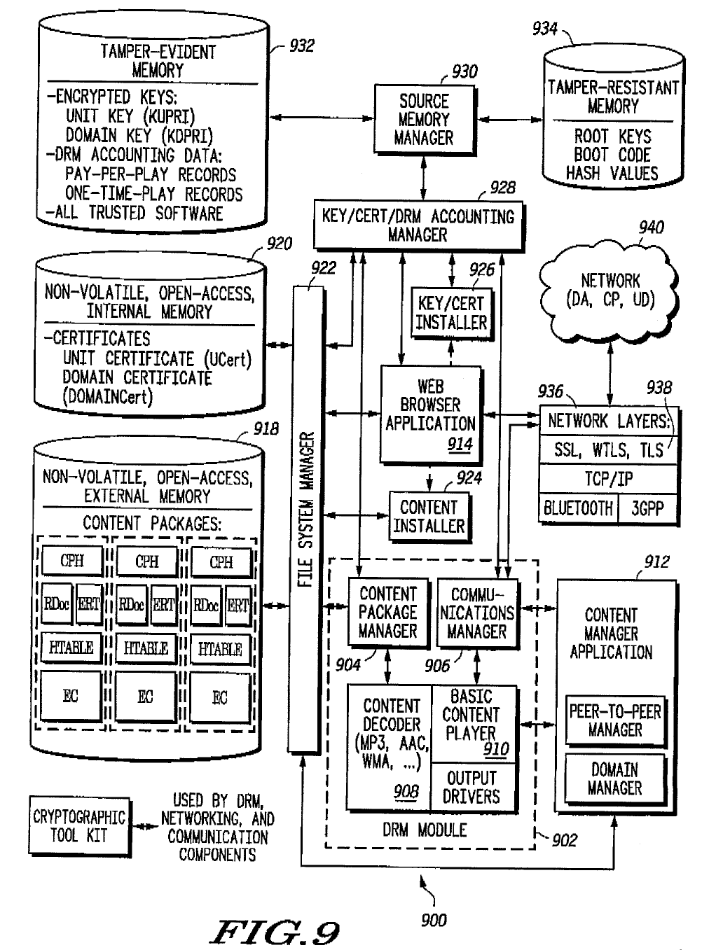

The architecture of an exemplary user device is shown in the block diagram 900 of FIG. 9 in which various memory and software components responsible for securely accessing, managing, and rendering content on a user device 202 are illustrated. The core digital rights management software 902, referred to as the digital rights management module and shown within the dashed lines of the figure, consists in this exemplary embodiment of a content packager manager 904, a communications manager 906, a content decoder 908, and a content player 910. Of course, it is understood that the functionality of these components of the digital rights management module 902 may be provided by a different architecture without departing from the spirit and scope of the invention. The digital rights management module core software is responsible for handling the decrypted content and keeping it secure. In addition to this core, there is a need for various levels of support software to handle tasks such as file and key management, networking, and various cryptographic functions. There are also two applications that users can launch to purchase and access content. These applications are the content manager application 912 and the web browser application 914. The software applications are described herein are assumed to be trusted in that they do not contain viruses and have been verified to not compromise secure data or keys. A trusted entity, such as the device manufacturer, is responsible for confirming that the user device's software and applications adhere to these rules.

Encrypted content received by the user device may be stored in content packages 916 which are kept in non-volatile memory 918 of the user device, as shown in the figure. This non-volatile memory is open-access memory and security is maintained by encrypting the content in the content packages rather than restricting access to this memory. In a user device, open-access memory can be either internal or external to the user device. Public data that is tied to a specific user device or domain, such as the public-key certificates, is preferably in internal memory 920. Content packages, which are likely to be much larger, can be stored in an external removable flash card, such as a Multimedia Card (MMC) removable flash memory card that can be used for this memory.

The open-access memory 918, 920 is managed using a file system manager 922. This file manager is responsible for file manipulation, including low-level input and output routines. Higher-level software applications go through the file manager to create, modify, read, and organize the files in the open-access memory. For example, the user device's web browser application 914 may be used to purchase content packages from an on-line content provider. Users may wish to copy newly purchased content packages into a removable memory card. These new content packages will have a certain file extension, such as “.cpk”, that will be associated with a helper application. After the browser downloads a content package, the helper application will be launched to install the content package. This content installer 924 will then contact the file system manager to store the newly received content.

The web browser 914 may also be used when a user wants to join or leave a domain. In the case of joining a domain, the user would visit the domain authority's website to obtain the domain private key and public-key certificate, in the preferred embodiment. The browser would securely download this data and a key/cert installer program 926 would automatically install the new keys and certificates. The installer program 926 would need to decrypt the incoming key and pass it to a software module 928 that manages the user device's secure memory 930.

There are two types of secure memory on a user device. The first type is a tamper-evident memory 932. In the preferred embodiment, this memory is used to store encrypted versions of the device's private keys, such as a unique unit key (KuPri) and a shared domain key (KdPri). Tracking data for digital rights management activities, such as pay-per-play or one-time-play, and the software for the user device is also stored in this memory. This memory is tamper-evident because its integrity can be verified using secure cryptographic hash values and signatures.

The hash values for the tamper evident memory are stored in a second type of secure memory 934 that is tamper resistant. This type of memory will resist hacker's attempts to read or alter its contents. In the preferred embodiment, the highly confidential key used to encrypt KuPri and KdPri will be stored in this memory. Also, boot code and root keys that ensure the secure operation of the user device's software reside in this memory. The boot code is responsible for launching the user device's operating system and for verifying the integrity of software on the user device.

The secure memories 932, 934 may be accessed through a secure memory manager 930. This manager is responsible for storing and retrieving data from the tamper-evident memory 932 and for properly updating the corresponding hash values in the tamper-resistant memory 934. The secure memory manager 930 will also check for tampering of the tamper-evident memory 932. The key/cert/digital rights management accounting manager 928 will interface to the secure memory manager 930 whenever new keys or digital rights management activities require that the secure memory be updated.

The final portion of the digital rights management support software is the networking layers 936. In particular, a secure network layer 938, such as SSL, TLS, or WTLS, will be used by the digital rights management applications. These security layers provide standard methods for establishing secure communications channels between a user device and a server (such as a domain authority, a content provider, or another user device) in a network 940. The network layers will be accessed by the browser application as well as the digital rights management communications manager, which is part of the core digital rights management module software.

The core digital rights management software of a user device, referred to as the digital rights management module of a communication device, securely handles the decrypted content and is used by a content manager application that is run by the user to render and manipulate content. In a music example, this manager will be the application that is used to play songs and create playlists. The user interface of this application will display song information, such as song title, playing time, and artist. This application will also provide the user interface for managing a peer-to-peer connection and for controlling domain preferences. The content manager will preferably have a direct link to the file system manager so that it can keep track of which content packages are available for play.

When a user decides to play a particular piece of content, the content manager invokes the core digital rights management software. The basic content player is responsible for playing the content, and rendering it to the output devices. However, before the content can be played it must be decoded, and before that, it must be decrypted. The content package manager is a software module operable to process and decrypt the content packages.

The content decoder software will ask the content package manager to “open” a content package. A content package is “opened” by verifying the package's rights document, hash, and encoded rights table. If the rules confirm that the package can be opened and accessed, then the content package manager will begin to read and decrypt the encrypted content. The decrypted content is sent via buffers to the content decoder, which decompresses the content and passes it along the basic content player for rendering. If the content package manager detects a rules violation, then an error code is returned. The content package manager is also responsible for updating digital rights management accounting data by contacting the key/cert/DRM accounting manager whenever rending a piece of content requires an update to occur.

The communications manager of the core digital rights management routines is responsible for setting up communication links to other devices. These links might be used for streaming, copying, loaning, or moving content to other trusted devices. Whenever possible, the communications manager will use the security components of the networking software to establish secure channels.

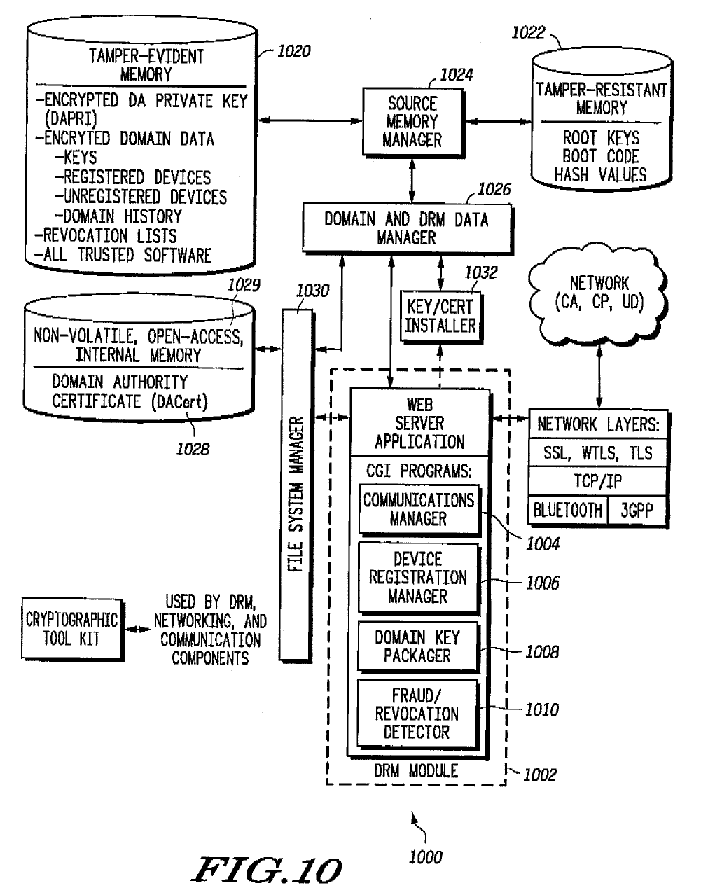

Referring to FIG. 10, operation of the domain authority 204 within a domain-based digital rights management system and method, in which the various entities used by a domain authority to securely register and remove communication user devices to and from domains, is illustrated in block diagram 1000. The core digital rights management software and/or firmware 1002, designated by the dashed box, is a web server application of the preferred embodiment that consists of a communications manager 1004, a device registration manager 1006, a domain key packager 1008, and a fraud/revocation detector 1010. The core digital rights management support software 1002 of the domain authority is accessed by common gateway interface (CGI) programs that are triggered by the web server application. The common gateway interface programs are part of the core digital rights management software of the domain authority. As with the user device, there is a need for various levels of support software to handle tasks such as memory management, networking, and various cryptographic functions.

Similar to a Certificate Authority (CA), the domain authority is assumed to be a trusted server that is operating in an environment secure from physical attacks. Support software in a domain authority is responsible for maintaining the security of this private data, which may include the private domain keys, the listing of all registered and unregistered devices, the historical accounts of domain registration activities, the device revocation lists, and the trusted digital rights management software. This data is preferably stored in tamper-evident memory 1020 and some of this data is also encrypted.

In order to detect tampering in the tamper-evident memory 1020, there is a need for tamper resistant memory 1022. As discussed in conjunction with the user device above, a secure memory manager 1024 is used for storing and retrieving data from the tamper-evident memory 1020 and for properly updating the corresponding hash values in the tamper-resistant memory 1022.

In the preferred embodiment, the tamper-evident database of domain data, keys, and certificates is handled by a Domain and digital rights management data manager 1026. This database manager 1026 can be queried for both the domain keys belonging to a particular user device, and the user devices belonging to a particular domain. Each domain authority also has a DAcert 1028 in an open-access memory 1029 that is used to authenticate the domain authority to the user device. The DACert is signed by the certificate authority and is exchanged with the user device when a secure communications channel is being established. Open-access memory 1029 is managed using a file system manager 1030. This file manager is responsible for file manipulation, including low-level input and output routines. Higher-level software applications go through the file manager to create, modify, read, and organize the files in the open-access memory.

The core digital rights management software of the domain authority handles the interactions between the domain authority and the user device and also communications between the domain authority and the content provider. A main component of the domain authority's digital rights management software is the web server application, previously mentioned. The web server serves up web pages to the user device, possibly in the form of WML for WAP-enabled user devices, for instance. These pages are part of a user interface (UI) that provide an easy-to-use interface for users to add or delete devices from a domain.

The web page to add a device to a domain will first find out if the user wishes to add a device to an existing domain or create a new domain. If a new domain is created, the user is queried to select a domain name and password. In a preferred embodiment, the domain authority may then initiate a secure authenticated connection with the user device, such as by using a WAP class 3 protocol or equivalent. In establishing this secure channel, the domain authority learns the unique, factory installed, unit public-key of the user device. The domain authority's device registration program uses this public-key along with the domain name and password to set up a new domain in the domain authority's digital rights management database. The domain authority finally creates a new private and public key pair for the new domain. The private key, along with instructions for using it, are placed into a file that is downloaded by the user device. The user device's key installer application 1032 will parse this key file to retrieve the instructions and the new domain key. The instructions will tell the user device to install the key into its memory, thereby registering the user device with that domain.

If the user wishes to add a device to an existing domain, the process is very similar. The user is queried for the name and password of the existing domain. The domain authority looks up this domain, verifies the password, and confirms that the limit for the number of devices in the domain has not been reached. If the limit has not been reached, then the domain authority adds the user device to the domain, retrieves the domain's private key, packages the key, and then provides it to the user device over a secure authenticated channel.

If the user wishes to remove a device from a domain, the domain authority first sets up a secure channel to determine and authenticate the user device's public key. The domain authority then looks up this public-key in its database to find out in which domain(s) the user device is a member. The user of the user device is then asked to select from which domain or domains membership of the user device should be removed. The domain authority will then process this information and create a key removal package that is downloaded by the user device. The user device's key installer program 1032 will parse this package, remove the proper key, and send a confirmation message to the domain authority. The domain authority can now be assured that this user device is no longer a member of the domain or domains.

The domain authority also keeps a record of each user device's attempts to register or delete devices from domains. This history is monitored by a fraud/revocation detector 1010. Whenever suspicious activity is detected a warning message is sent to the domain authority's system operators. The operators can launch a further investigation to determine if the suspiciously acting user device should have its public key revoked. If needed, the domain authority will keep a list of revoked user devices and will refuse to service any user device that is on this list.

Finally, the domain authority also has the ability to communicate with a content provider. When selling content to a user device, the content provider asks the domain authority for a list of domains in which the user device is a member. The domain authority's communications manager will handle this request. The information gained by the content provider facilitates the transaction with the user device by providing a convenient method for the user of the user device to purchase content for one of these domains. If the domain authority and content provider do not wish to communicate, the user of the user device will supply the domain information.

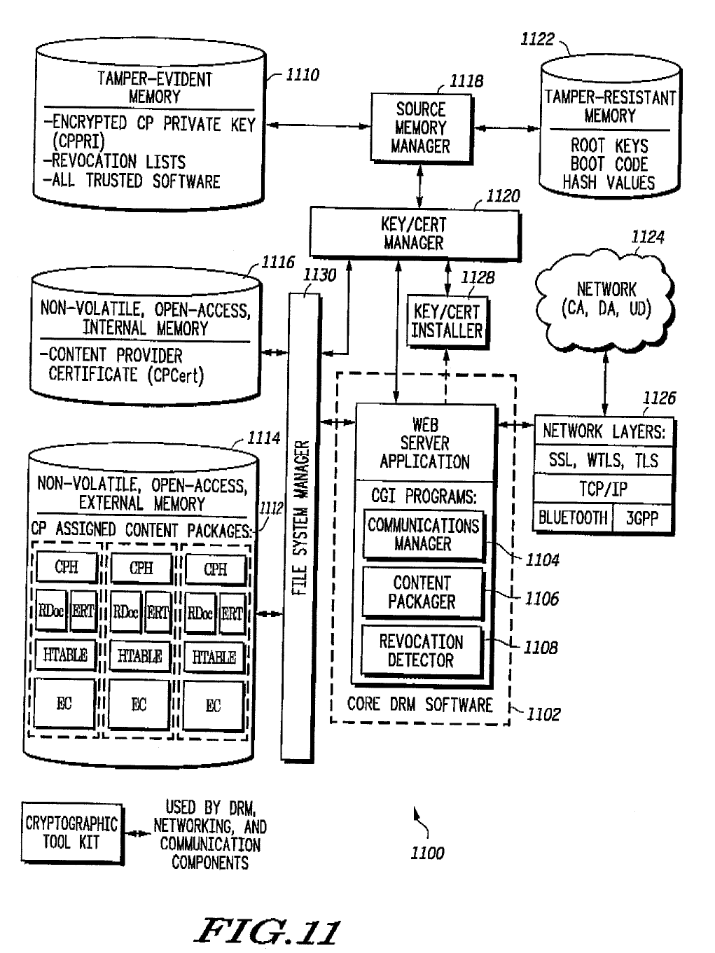

Referring now to FIG. 11, a block diagram 1100 that illustrates the architecture of a content provider (CP) 210, suitable for supplying requested content in a domain-based digital rights management environment, is shown. The core digital rights management software and/or firmware 1102 of the content provider is designed by the dashed box and includes functionality provided by a communications manager 1104, content packager 1106, and a revocation detector 1108. In a preferred embodiment of the invention, this functionality is provided by a web server application. Support software of the content provider performs tasks such as memory management, networking, and various cryptographic functions.

As with the user device and domain authority, tamper-evident memory 1110 is used to store the content provider's private key, the revocation list, and all of the trusted software. Content packages 1112 are kept in open access memory 1114. These packages are assigned to the content provider's public key, thus the content is encrypted with a key that only the content provider's private key can decrypt. When a user device buys a content package, the content provider's core digital rights management software reassigns the content package to the user device's public key.

The content provider's core digital rights management software 1102 handles interactions between the content provider 210 and the user device 202 and also communications between the domain authority 204 and the content provider 210. The main component of the content provider's digital rights management software is a web server application in a preferred embodiment. This application serves up web pages to the user device, possibly in the form of WML for WAP-enabled user devices. These pages provide an easy-to-use interface for users to purchase content for their domain devices.

The functionality of additional components of block diagram, including openaccess memory 1116, secure memory manager 1118, key/cert manager 1120, tamper-resistant memory 1122, network 1124, network layers 1126, and key/cert installer 1128, as similar to that described above in reference to FIGS. 9 and 10 for like-named components.

When setting up a secure authenticated channel by which user-requested content may be provided to the requesting user, the content provider would acquire the user device's private key in accordance with a preferred embodiment. The content provider could then contact the domain authority to determine the domain or domains that contain this particular user device. The content provider could optionally produce a web page asking the user of the user device to decide to which domain the new content should be assigned. The content provider would then reassign the content to this preferred domain. Alternatively, the user of the user device could manually enter the domain name (or URL) of the domain for which he wishes to purchase music. Again, the content provider would contact the domain authority for this domain's public-key certificate. The content package would then be accordingly assigned to this domain.

The newly reassigned package is then transferred to the user device, where it is subsequently installed. The user may also want to send the content to an online content account. If this is the case, the content provider can forward the content package, along with instructions, to the appropriate content bank.

The content provider has various Common Gateway Interface (CGI) programs that are invoked when certain websites are visited. One of these common gateway interface programs is the communications manager 1104 which handles the interactions between the content provider and the domain authority. The content package is reassigned to the user device using another common gateway interface program called the content packager 1106. Finally, revocation detection software 1108 is used to verify that the purchasing user device's public-key has not been revoked.

The domain-based approach of the present invention provides a convenient way for consumers to access digital content in which piracy of digital content prevented without the burdensome check-in and check-out policies of prior copy-based approaches. Access to content is restricted to the registered devices of one or more domains but content is accessible at any time and any place by registered domain devices. Trusted devices outside the domain will not automatically have access to intra-domain content but may be provided content if appropriate content protocols are supported. Because only registered devices are allowed access to the content, a check-in/check-out policy is not needed and a user's experience is greatly simplified and enhanced. Security is encountered by an end-user only when adding new devices to one or more domains. Security, however, stays strong, with content being protected using cryptographic techniques based upon strong encryption and security protocols.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. For instance, it is noted that the present invention is applicable to portable, wireless devices such as pagers, mobile phones, PCS devices, and Blue Tooth devices characterized as having a limited communication range, as well as to devices that are not necessarily mobile or wireless, such as automotive entertainment systems, set-top boxes that handle digital content, and home computers.

What is claimed is:

1. A communication device operable in a domain-based digital rights management environment, comprising:
a processing element;
a receiver, coupled to and controlled by the processing element, operable to receive incoming messages to the communication device;
a transmitter, coupled to and controlled by the processing element, operable to transmit output messages of the communication device; and
a digital rights management module coupled to the processing element that controls operation of the communication device within the domain-based digital rights management environment;
wherein the digital rights management module of the communication device in combination with a domain authority of the domain-based digital rights management environment is operable to selectively add the communication device to a domain having one or more communication devices that share a cryptographic key and thus permit the communication device to selectively receive and decrypt digital content based upon membership in the domain.

2. The communication device of claim 1, wherein the transmitter is a limited range transmitter having a limited communication range and operable to transit the digital content to a trusted communication device within the limited communication range.

3. The communication device of claim 1, wherein in response to receiving a user request, the digital rights management module causes the transmitter of the communication device to transmit to a domain authority a request to register the communication device into the domain; and
wherein if the communication device is determined to have access to one or more valid cryptographic elements, the digital rights management module causes the receiver of the communication device to receive over a communications channel the cryptographic key of the domain from the domain authority to link the communication device to the domain.

4. The communication device of claim 3, wherein the digital rights management module in combination with the domain authority removes the communication device from the domain, comprising:
in response to the request of the user of the domain to remove the communication device, the digital rights management module of the communication device causes the transmitter to transmit a request that the communication device be removed from the domain;
in response to the request that the communication device be removed from the domain, the communication device receives from the domain authority via the secure communications channel a command to remove the cryptographic key of the domain from the communication device; and
upon receiving the command from the domain authority, the digital rights management module of the communication device removes the cryptographic key of the domain.

5. The communication device of claim 1, wherein in response to the digital rights management module of the communication device causing the transmitter to transmit a request for digital content, at least one of the digital rights management module of the communication device and the domain authority verifies authenticity of the domain; and
wherein upon verification of the authenticity of the domain, the receiver of the communication device receives an encrypted form of the requested digital content that is bound to the cryptographic key of the domain in which the communication device is registered.

6. The communication device of claim 1, wherein the digital rights management module of the communication device enforces usage rules associated with the requested digital content and received by the receiver in a content package containing the requested digital content.

7. The communication device of claim 6, wherein the content package comprises a binary representation rights table that contains the usage rules.

8. The communication device of claim 7, wherein the binary representation rights table comprises a plurality of sections having predefined tokens.

9. The communication device of claim 1, wherein the digital rights management module, in response to the transmitter of the communication device receiving a request from a second communication device of the domain requesting the digital content, causes the transmitter to transmit the requested digital content from a storage element to the second communication device.

10. The communication device of claim 1, wherein in response to a request of the user of the communication device, the digital rights management module causes the transmitter to transmit a request for digital content that is not available in the domain; and
wherein after authenticity of the domain has been verified, the receiver receives an encrypted form of the requested digital content that is bound to the cryptographic key of the domain to which the communication device is registered.

11. The communication device of claim 10, wherein the encrypted form of the requested digital content is contained in a content package.

12. The communication device of claim 11, wherein the content package further comprises a binary representation rights table that contains the usage rules of the requested digital content.

13. The communication device of claim 12, wherein the binary representation rights table comprises a plurality of sections having predefined tokens.

14. The communication device of claim 10, wherein the digital rights management module of the communication device stores the encrypted digital content in an open-access storage element.

15. The communication device of claim 10, wherein the digital rights management module of the communication device enforces usage rules associated with the requested digital content and received by the receiver in a content package containing the requested digital content.

16. The communication device of claim 15, wherein the content package comprises a binary representation rights table that contains the usage rules.

17. The communication device of claim 16, wherein the binary representation rights table comprises a plurality of sections having predefined tokens.

18. The communication device of claim 1, wherein in response to the receiver receiving a request from a second communication device of the one or more communication devices of the domain for the digital content and the digital rights management module verifying the authenticity of the second communication device, the digital rights management module causing the transmitter to transmit the requested digital content from a storage element of the communication device to the second communication device.

19. The communication device of claim 1, wherein the digital rights management module causes digital legacy content received from a source external to the domain to be stored in a storage element of the communication device; and
wherein in response to a request from a second communication device of the domain, the digital rights management module causes the transmitter to transmit the digital legacy content from the storage element to the second communication device.

20. A method of operation of a communication device of a domain having one or more communication devices that share a cryptographic key in a domain-based digital rights management environment, comprising:
in response to a user request, the communication device communicating to a domain authority a request to register the communication device into a domain; and
if the communication device is determined to have access to one or more valid cryptographic elements, the communication device receiving over a communications channel a cryptographic key of the domain from the domain authority that links the communication device to the domain.

21. The method of claim 20, further comprising:
the communication device, of a domain having one or more communication devices that share a cryptographic key of the domain, requesting digital content;
in response to the communication device requesting digital content, at least one of the communication device and the domain authority verifying authenticity of the domain; and
upon verification of the authenticity of the domain, the communication device receiving an encrypted form of the requested digital content that is bound to the cryptographic key of the domain to which the communication device is registered.

22. The method of claim 21, further comprising the communication device enforcing usage rules associated with the requested digital content and received in a content package containing the requested digital content.

23. The communication device of claim 22, wherein the content package comprises a binary representation rights table that contains the usage rules.

24. The communication device of claim 23, wherein the binary representation rights table comprises a plurality of sections having predefined tokens.

25. The method of claim 21, further comprising:
a second communication device of the one or more communication devices of the domain requesting the digital content; and
transferring the requested digital content from a storage element to the second communication device.

26. The method of claim 20, wherein removing the communication device from the domain comprises:
in response to the request of the user of the domain to remove the communication device, the communication device transmitting a request that the communication device be removed from the domain; and
in response to the request that the communication device be removed from the domain, the communication device receiving from the domain authority via the secure communications channel a command to remove the cryptographic is key of the domain from the communication device.

27. The method of claim 26, further comprising:
upon receiving the command from the domain authority, the communication device removing the cryptographic key of the domain.

28. The method of claim 20, wherein prior to the communication device communicating to a domain authority the request to register the communication device into the domain, further comprising the communication device:
communicating to the domain authority a request to establish the domain, said request having a domain name and a domain password;
communicating to the domain authority via a communications channel a unique identifier of the communication device;
downloading the cryptographic key created by the domain authority;

29. The method of claim 20, further comprising:
In response to a request of the user of the communication device, the communication device requesting digital content that is not available in the domain; and
after authenticity of the domain has been verified, the communication is device receiving an encrypted form of the requested digital content that is bound to the cryptographic key of the domain to which the communication device is registered.

30. The method of claim 29, wherein the encrypted form of the requested digital content is contained in a content package having usage rules enforced by the communication device.

31. The communication device of claim 29, wherein the content package comprises a binary representation rights table that contains the usage rules.

32. The communication device of claim 31, wherein the binary representation rights table comprises a plurality of sections having predefined tokens.

33. The method of claim 29, further comprising the communication device storing the encrypted digital content in an open-access storage element.

34. The method of claim 29, further comprising:
the communication device receiving a request from a second communication device of the one or more communication devices of the domain requesting the digital content;
the communication device verifying the authenticity of the second communication device; and
if the authenticity of the second communication device is verified, the communication device transferring the requested digital content from a storage element of the communication device to the second communication device.

35. The method of claim 20, further comprising:
the communication device receiving digital legacy content from a source external to the domain and storing it in a storage element of the communication device; and
in response to a request from a second communication device of the domain, the communication device transmitting the digital legacy content from the storage element to the second communication device.

36. A method for registering devices in a domain having one or more communication devices that share a cryptographic key in a domain-based digital rights management environment, comprising:
a domain authority receiving a request to add a communication device to the domain;
the domain authority determining whether the communication device is legitimate by verifying that the communication device has access to one or more valid cryptographic elements;
if the communication device is determined to be valid, the domain authority transmitting over a communications channel to the communication device a cryptographic key of the domain operable to link the communication device to the domain.

37. The method of claim 36, wherein prior to the domain authority transmitting the cryptographic key to the communication device further comprising:
The domain authority determining that the one or more communication devices of the domain do not exceed a predetermined upper limit.

38. The method of claim 36, further comprising prior to receiving a request to add the communication device to the domain, the domain authority receiving a request to create the domain having a domain name and a domain password;
the domain authority initiating the communications channel with the communication device;
the domain authority determining a unique identification of the communication device;
the domain authority establishing the domain using the unique identification of the communication device, the domain name, and the domain password;
the domain authority creating the cryptographic key of the domain; and
the domain authority providing the cryptographic key for download by the communication device.

39. The method of claim 36, further comprising:
in response to a communication device of the domain requesting digital content, the domain authority verifying authenticity of the domain.

40. The method of claim 36, wherein removing the communication device from is the domain comprises the domain authority:
receiving the request to remove the communication device from the domain;
authenticating the communication device; and
upon authenticating the communication device the domain authority transmitting via a secure communications channel to the communication device a command to remove the cryptographic key of the domain from the communication device.

41. The method of claim 36, further comprising the domain authority:
maintaining a log of requests by the communication device to register to or be deleted from one or more domains;
monitoring the log to identify potentially fraudulent activity by the communication device; and
generating a warning message in response to identifying potentially fraudulent activity by the communication device.

42. The method of claim 41, further comprising revoking a public key of the communication device if the communication device is determined to be engaged in fraudulent activity.

43. A domain-based digital rights management system, comprising:
a communication device linked via a first communications link to a domain-based digital rights management environment, comprising:
a processing element;
a receiver, coupled to and controlled by the processing element, operable to receive incoming messages to the communication device;
a transmitter, coupled to and controlled by the processing element, operable to transmit output messages of the communication device; and
a digital rights management module coupled to the processing element that controls operation of the communication device within the domain-based digital rights management system;
a domain authority coupled to the communication device via a second communications link;
wherein the digital rights management module of the communication device in combination with the domain authority are operable to selectively add the communication device to a domain having one or more communication devices that share a cryptographic key and thus permit the communication device to selectively receive and decrypt digital content based upon membership in the domain.

44. A method of limiting access to digital content in a domain-based digital rights management environment, comprising:
a first communication device, of a domain having one or more communication devices that share a cryptographic key of the domain, requesting digital content;
in response to the request from the first communication device, verifying authenticity of the domain; and
upon verifying authenticity of the domain, making the requested digital content accessible to the first communication device by binding an encrypted form of the requested digital content to the cryptographic key of the domain to which the first communication device is registered.

45. The method of claim 44, wherein the encrypted form of the requested digital content is contained in a content package having usage rules enforced by the first communication device.

46. The communication device of claim 45, wherein the content package comprises a binary representation rights table that contains the usage rules.

47. The communication device of claim 46, wherein the binary representation rights table comprises a plurality of sections having predefined tokens.

48. The method of claim 44, wherein prior to the first communication device requesting digital content establishing the domain, said establishing further comprising:
in response to a user request, the first communication device communicating to a domain authority a request to register the first communication device into the domain;
the domain authority determining whether the first communication device is legitimate by verifying that the first communication device has access to one or more valid cryptographic elements; and
the first communication device receiving over a communications link a cryptographic key of the domain from the domain authority that links the first communication device to the domain.

49. The method of claim 44, further comprising:
a second communication device of the one or more communication devices of the domain requesting the digital content; and
transferring the requested digital content from a storage element to the second communication device.

50. The method of claim 44, further comprising:
a second communication device of the one or more communication devices of the domain receiving digital legacy content from a source external to the domain and storing it in a storage element of the second communication device; and
In response to a request from a third communication device of the domain, the second communication device transmitting the digital legacy content from the storage element to the third communication device.

51. The method of claim 44, further comprising removing a second communication device from the domain in response to a request from a user of the domain.

52. The method of claim 51, wherein removing the second communication device from the domain comprises:
in response to the request of the user of the domain to remove the second communication device, the second communication device transmitting a request to the domain authority to remove the second communication device from the domain;
in response to the request that the second communication device be removed from the domain, the domain authority transmitting a command via the secure communications channel to remove the cryptographic key of the domain from the second communication device; and
upon receiving the command from the domain authority, the second communication device removing the cryptographic key of the domain resident on the second communication device.

53. The method of claim 52, wherein the request that the second communication device be removed from the domain is made by the user at a website of the domain authority.
